(19) United States
(12) Patent Application Publication
(10) Pub. No.: US 2022/0118570 A1
(43) Pub. Date: Apr. 21, 2022

(54) Machine Tool

(71) Applicant: DECKEL MAHO Pfronten GmbH, Pfronten (DE)

(72) Inventor: Robert JUNG, Pfronten (DE)

(21) Appl. No.: 17/423,878

(22) PCT Filed: Dec. 13, 2019
(86) PCT No.: PCT/EP2019/085072

§ 371 Date: Jul. 18, 2021

(30) Foreign Application Priority Data
Feb. 11, 2019 (DE) 10 2019 201 750.9

(51) Int. Cl. B23Q 3/157

(52) U.S. Cl. CPC B23Q 3/15713

(57) ABSTRACT

The present invention relates to a machine tool 1000, comprising: a machine table 200 pivotable about a pivot axis 230 for clamping a workpiece WS, a workpiece magazine 300 with a plurality of magazine locations 310 for receiving respective workpieces WS, and a workpiece changing device 400 for introducing or exchanging a workpiece WS on the machine table 200, wherein the pivotable machine table 200 is configured to pivot into a changing position for introducing or exchanging the workpiece WS on the machine table 200 by means of the workpiece changing device, and the workpiece changing device 400 is configured to introduce or exchange the workpiece on the machine table 200 pivoted into the changing position.

The present invention relates to a machine tool.

### BACKGROUND OF THE INVENTION

Automatic changing processes in a machine tool, in particular when changing tools that are received in a work spindle of the machine tool, are a widespread option of increasing the degree of automation of a machine tool and the machining processes that take place therein and essentially belong to the known state of the art.

However, further developments in the area of automatic changing processes and improvements to existing systems are desired, in particular with regard to changing workpieces that are clamped or are to be clamped on a machine table of the machine tool.

Here, the aim is always that the machine tools enable fast changing times and short downtimes during the changing processes. The machine tools should further have a compact design and be able to hold a large number of tools or workpieces in appropriate storage locations, such as magazines, for future machining processes.

### SUMMARY OF THE INVENTION

An object of the present invention is to provide a machine tool having improved automation properties while being of a compact design.

To achieve this object, a machine tool according to claim 1 is proposed. The dependent claims relate to advantageous exemplary embodiments of the machine tool according to the invention.

The machine tool according to the invention comprises: a machine table pivotable about a pivot axis for clamping a workpiece, a workpiece magazine with a plurality of magazine locations for receiving respective workpieces, and a workpiece changing device for introducing or exchanging a workpiece on the machine table, wherein the pivotable machine table is configured to pivot into a changing position for introducing or exchanging the workpiece on the machine table by means of the workpiece changing device, and the workpiece changing device is configured to introduce or exchange the workpiece on the machine table pivoted into the changing position.

In a simple manner, the machine tool according to the invention made it possible to achieve an improvement in the degree of automation so that machine tables that have a pivot axis, for example, can now be automatically equipped by a workpiece changing device.

For this purpose, it is particular advantageous when the pivot axis can be deliberately included in the process of changing the workpiece since this results in significantly more possibilities for the workpiece changing device to change the workpiece, also with regard to the time factor.

Furthermore, a workpiece changing device configured for such a workpiece change on a pivotable machine table is advantageous in that it is enabled by the gripper portion, such as the fork of a fork changer (also often used for tool changing processes on work spindles), and the presence of various drives such as linear axes, rotary drives and/or lifting drives to change the workpieces clamped on the machine table in various movement sequences and to carry out the change processes quickly.

An advantageous development of the machine tool according to the invention is that the workpiece magazine has at least one rotational axis around which the workpiece magazine includes a plurality of radially aligned magazine locations for receiving respective workpieces.

Another essential point in such workpiece changing processes is, on the one hand, the presence of a workpiece magazine and, on the other hand, the design or characteristic features of the magazine. Particularly in the case of workpiece magazines with arcuate and/or radially arranged magazine locations, the positioning options of the workpiece changing device on the one hand and the machine table on the other hand may have considerable influence on a safe and quick change of the workpiece, so that the three components magazine—change—machine table can interact with each other in an advantageous manner.

In addition, by means of radially arranged magazine locations (as they exist, for example, in wheel magazines or in some cases in chain magazines), workpieces may now be provided and stored in a particularly space-saving manner for the automated change of workpieces on the machine table.

Furthermore, the machine tool according to the invention may advantageously be further developed in that the pivotable machine table includes a clamping device oriented perpendicular to the pivot axis for clamping a workpiece, wherein, in the changing position of the machine table, the clamping device of the machine table is oriented substantially in parallel and/or substantially identically to a magazine location of the workpiece magazine, from which the workpiece is picked up by the workpiece changing device and introduced into the clamping device of the machine table or into which the workpiece is inserted from the clamping device of the machine table by the workpiece changing device.

As a result and advantageously, the workpieces can now be moved between the clamping device of the machine table and the workpiece magazine and introduced or exchanged there with a few displacement movements on the part of the workpiece changing device.

An advantageous development of the machine tool according to the invention is that the workpiece changing device includes a gripper portion configured to grip the workpiece on the clamping device of the machine table and/or at one of the plurality of magazine locations of the workpiece magazine, wherein the workpiece changing device includes a rotational axis about which the gripper portion is rotatable and which, when the workpiece is gripped by the gripper portion, is arranged substantially in parallel to the orientation of the clamping device of the machine table and/or the corresponding magazine location of the plurality of magazine locations of the workpiece magazine.

As a result, the workpieces can now simply be gripped by the gripper portion of the workpiece changing device and appropriately positioned for the introduction or exchange process.

Furthermore, the machine tool according to the invention may advantageously be further developed in that the workpiece changing device picks up the workpiece from a magazine location of the plurality of magazine locations of the workpiece magazine or deposits the workpiece in a magazine location of the plurality of magazine locations of the workpiece magazine, said magazine location being located in a horizontal plane extending through the rotational axis of the workpiece magazine and/or located below the horizontal plane extending through the rotational axis of the workpiece magazine.

Moreover, the machine tool according to the invention may be advantageously developed in that the rotational axis of the workpiece changing device, about which the gripper portion of the workpiece changing device can be rotated, is arranged substantially horizontally.

Such a horizontally arranged workpiece changing device can advantageously pick up the workpieces from the magazine location of the workpiece magazine which is arranged in the horizontal plane extending through the rotational axis of the workpiece magazine. This is one of the most common machine tool designs.

Furthermore, the machine tool according to the invention may be advantageously developed in that the rotational axis of the workpiece changing device, around which the gripper portion of the workpiece changing device can be rotated, is arranged substantially vertically.

Moreover, the machine tool according to the invention may advantageously be further developed in that the rotational axis of the workpiece changing device, around which the gripper portion of the workpiece changing device can be rotated, is arranged substantially between a horizontal and a vertical arrangement.

However, in addition to the horizontal or reclined arrangement, the workpiece changing device may also be arranged vertically, for example below the workpiece magazine, or at a certain angle in the machine tool, as required. This may be influenced, for example, by the length of the workpieces to be changed in order to determine the optimal position of the workpiece changing device in the machine tool or with respect to the workpiece magazine.

Another advantageous development of the machine tool according to the invention is that the workpiece can be picked up from the clamping device of the machine table and/or from a magazine location of the plurality of magazine locations of the workpiece magazine via a standardized interface, in particular an HSK interface or a steep-taper interface, or a user-specific interface.

As a result, a wide variety of interfaces can now be operated by the workpiece magazine or by the clamping device of the machine table and the machine tool can thus be adapted even more flexibly to the requirements of the respective machining process.

A further advantageous development of the machine tool according to the invention is that the workpiece changing device is movable between the workpiece magazine and the pivotable machine table via a linear axis.

In addition, the machine tool according to the invention may advantageously be further developed in that the workpiece changing device is configured to position the gripper portion of the workpiece changing device for gripping the workpiece on the clamping device of the machine table when introducing or exchanging the workpiece clamped by the machine table by moving the workpiece changing device along the linear axis and at the same time starting to position the gripper portion by rotating about the rotational axis of the workpiece changing device.

This enables the workpiece changing device to introduce or exchange the clamped workpiece in a short time by superimposing a linear displacement movement and a rotary movement of the gripper portion of the workpiece changing device. In particular, this can be used to compensate for a possible height offset between the rotational axis of the workpiece changing device/the magazine location of the workpiece magazine and the clamping device of the machine table without having to rely on a vertical linear unit (or a similar additional movement mechanism).

This also allows for considerable improvement in the automation of the machining of workpieces on machine tools or on pivotable machine tables. For this purpose, the design of the machine tables is irrelevant and may comprise machine tables mounted on two sides (for example with a U-shaped bridge or straight bridge) as well as machine tables mounted on one side, as for example described in patent applications DE 10 2004 049 525 B3 and DE 10 2012 201 736 B3.

Moreover, the machine tool according to the invention may advantageously be developed in that the pivotable machine table is configured as a swivel rotary table.

The possibility of additionally carrying out a positioning that changes the position of the workpiece expands the application options of the machine table enormously, so that, on the one hand, significantly more complex geometries of the workpiece can be generated in one clamping (in particular in conjunction with the use of the pivot axis of the pivotable machine table).

Furthermore, the machine tool according to the invention may advantageously be further developed in that the pivotable machine table includes a rotational axis which is oriented perpendicular to the swivel axis and around which the clamping device of the machine table can be rotated for clamping the workpiece and the machine table is configured to position the clamping device of the machine table by rotating in order to allow for the workpiece clamped by the clamping device of the machine table to be gripped by the gripper portion of the workpiece changing device.

This now allows the gripper to grip a wide variety of workpieces or interfaces via which the workpiece can be clamped on the machine table, since these sometimes require a defined relative position with respect to the gripper or gripper portion so that they can be gripped by the workpiece changing device (in particular the gripper portion) for a workpiece change.

Furthermore, the machine tool according to the invention may advantageously be further developed in that the machine table is configured to rotatably position the clamping device of the machine table depending on the interface of the workpiece, via which the workpiece can be picked up from the clamping device of the machine table and/or from a magazine location of the plurality of magazine locations of the workpiece, in order to allow for the workpiece clamped by the clamping device of the machine table to be gripped by the gripper portion of the workpiece changing device, or the machine table is configured to rotatably position the clamping device of the machine table depending on the interface of the workpiece, via which the workpiece can be picked up from the clamping device of the machine table and/or from a magazine location of the plurality of magazine locations of the workpiece magazine, and depending on the relative position of the interface with respect to the gripper portion of the workpiece changing device in order to allow for the workpiece clamped by the clamping device of the machine table to be gripped by the gripper portion of the workpiece changing device.

An advantageous development of the machine tool according to the invention is also that the workpiece changing device includes a vertical axis configured to vertically move the gripper portion and the rotational axis of the workpiece changing device, wherein, when changing the workpiece clamped on the machine table, for gripping the workpiece on the clamping device of the machine table, the workpiece changing device is configured to move the gripper portion and the rotational axis of the workpiece changing device along the vertical axis in order to allow for the workpiece clamped by the clamping device of the machine table to be gripped by the gripper portion of the workpiece changing device.

This advantageously allows for the workpiece changing device (in particular the gripper portion) to be positioned with respect to the workpiece clamped on the machine table in a variety of ways, which may be advantageous depending on the type of machine table used. In particular, very different combinations of positioning movements can be generated in this way in order to support the process of changing the workpiece or to enable it in the first place.

Moreover, the machine tool according to the invention may advantageously be further developed in that the gripper portion includes a controllable lifting mechanism by which the gripper portion can be moved translationally in the direction of the rotational axis of the workpiece changing device, so that the workpiece can be picked up from the clamping device of the machine table and/or from the corresponding magazine location of the plurality of magazine locations of the workpiece magazine and/or the workpiece can be introduced into the clamping device of the machine table and/or into the corresponding magazine location of the plurality of magazine locations of the workpiece magazine.

Furthermore, the machine tool according to the invention may be advantageously developed in that the workpiece magazine comprises at least one workpiece magazine portion, preferably a plurality of workpiece magazine portions, which substantially rotatable about the rotational axis of the workpiece magazine and each of which includes a plurality of radially oriented magazine locations for receiving respective workpieces.

This makes it possible to use the workpiece magazine in the most varied of ways: for example, a different raw part can be provided as the workpiece for each workpiece magazine portion, or some of the workpiece magazine portions store the raw parts while the other workpiece magazine portions store the finished workpieces. There are no limits to the possibilities of using the workpiece magazine portions in a wide variety of ways.

In particular, the machine tool according to the invention may be advantageously developed in that the workpiece magazine is configured as a wheel magazine.

A wheel magazine or a plurality of wheel magazine portions are particularly advantageous because they allow for the desired workpiece to be provided very quickly and can store a large number of workpieces in a comparatively small space.

The machine tool according to the invention made it possible to achieve an improvement in the degree of automation in a simple manner, so that machine tables, which for example have a pivot axis, can now be automatically equipped by a workpiece changing device. For this purpose, it is particularly advantageous that the pivot axis could deliberately be included in the process of changing the workpiece, since this results in significantly more possibilities for the workpiece changing device to change the workpiece, also with regard to the time factor.

Furthermore, a workpiece changing device configured for such a workpiece change on a pivotable machine table is advantageous in that it is enabled by to its gripper portion, such as the fork of a fork changer (also often used in tool changing processes on work spindles) and the presence of various drives such as linear axes, rotary drives and/or lifting drives to change the workpieces clamped on the machine table in various movement sequences and to carry out the change processes quickly.

As an example, a method for changing a workpiece on a machine tool is described, wherein the machine tool comprises a machine table pivotable about a pivot axis for clamping the workpiece, a workpiece magazine with a plurality of magazine locations for receiving the respective workpieces, and a workpiece changing device for introducing or exchanging the workpiece on the machine table, the method comprising: pivoting the pivotable machine table into a change position for introducing or exchanging the workpiece on the machine table, and introducing or exchanging the workpiece on the machine table pivoted into the change position by means of the workpiece changing device.

This exemplary method may also be adapted in that the workpiece magazine includes at least one rotational axis around which the workpiece magazine has a plurality of radially oriented magazine locations for receiving respective workpieces.

This exemplary method may also be adapted in that the pivotable machine table includes a clamping device oriented perpendicular to the pivot axis for clamping a workpiece, wherein, in the changing position of the machine table, the clamping device of the machine table is oriented substantially in parallel and/or substantially identically to one magazine location of the plurality of radially oriented magazine locations of the workpiece magazine from which the workpiece is picked up by the workpiece changing device and introduced into the clamping device of the machine table or into which the workpiece is introduced from the clamping device of the machine table by the workpiece changing device.

This exemplary method may also be adapted in that the workpiece changing device is movable between the workpiece magazine and the pivotable machine table via a linear axis and the pivotable machine table is substantially U-shaped, wherein the pivot axis of the machine table is arranged at the open end of the substantially U-shaped machine table and the workpiece is clamped on the portion of the substantially U-shaped machine table opposite the open end, the exemplary method now comprising: positioning a gripper portion of the workpiece changing device for gripping the workpiece at the clamping device of the machine table in the area between the two legs of the substantially U-shaped machine table by: moving the workpiece changing device along the linear axis to the machine table pivoted to the changing position, and, at the same time, starting to rotate the gripper portion of the workpiece changing device about a rotational axis of the workpiece changing device, the rotational axis of the workpiece changing device being arranged substantially in parallel to the orientation of the clamping device of the machine table and/or the corresponding magazine location of the plurality of radially oriented magazine locations of the workpiece magazine.

This exemplary method may also be adapted in that the workpiece changing device includes a vertical axis configured to vertically move the gripper section and the rotational axis of the workpiece changing device, wherein, when changing the workpiece clamped on the machine table, for gripping the workpiece on the clamping device of the machine table, the workpiece changing device is configured to move the gripper portion and the rotational axis of the workpiece changing device along the vertical axis in order to allow for the workpiece clamped by the clamping device of the machine table to be gripped by the gripper portion of the workpiece changing device.

Further aspects and advantages thereof as well as advantages and advantages and more specific implementation possibilities of the aspects and features described above are described in the following descriptions and explanations regarding the attached figures, which are in no way restrictive.

### BRIEF DESCRIPTION OF THE DRAWINGS

FIG. 1 schematically shows an embodiment of the machine tool according to the invention in a traveling column design with a vertically arranged work spindle and a pivotable machine table;

FIG. 2 schematically shows a further embodiment of the machine tool according to the invention as a horizontal processing machine with a horizontally arranged work spindle and a pivotable machine table;

FIG. 3 schematically shows a further embodiment of the machine tool according to the invention in a traveling column design with a vertically arranged work spindle, a pivotable machine table and an obliquely arranged workpiece changing device;

FIG. 4 schematically shows a further embodiment of the machine tool according to the invention as a horizontal processing machine with a horizontally arranged work spindle, a pivotable machine table and a workpiece changing device arranged below a workpiece magazine;

FIG. 5 schematically shows a further embodiment of the machine tool according to the invention in a traveling column design with a partition of the work space of the machine tool from the workpiece magazine and the workpiece changing device;

FIG. 6 schematically shows a further embodiment of the machine tool according to the invention in a traveling column design and a workpiece magazine with a plurality of workpiece magazine portions;

FIG. 7 schematically shows various combinations of movements of the workpiece changing device and the machine table for gripping the workpiece clamped on the machine table by the gripper portion of the workpiece changing device;

FIG. 8 schematically shows a further embodiment of the workpiece changing device with a further movement for introducing or exchanging the workpiece clamped on the machine table;

FIG. 9 schematically shows different variants of workpiece carriers with different interfaces.

### DETAILED DESCRIPTION OF THE DRAWINGS AND PREFERRED EMBODIMENTS OF THE PRESENT INVENTION

In the following, examples and exemplary embodiments of the present invention are described in detail with reference to the accompanying figures. Identical or similar elements in the figures can be denoted by the same reference symbols, but sometimes also with different reference symbols.

It should be emphasized that the present invention, however, is in no way limited or restricted to the exemplary embodiments described below and implementation features thereof, but rather further comprises modifications of the exemplary embodiments, and in particular those that result from modifications of the features of the examples described or from combinations of one or more of the features of the examples described are included within the scope of protection of the independent claims.

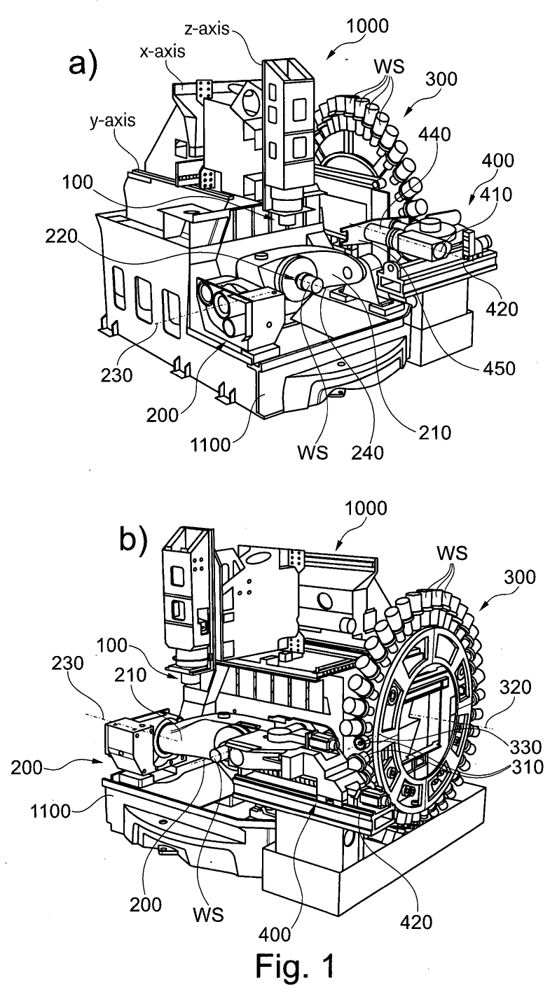

FIG. 1 schematically shows an embodiment of the machine tool 1000 according to the invention in a traveling column design with a vertically arranged work spindle 100 and a pivotable machine table 200.

FIG. 1 shows the machine tool 1000 according to the invention in two views (here view a) and view b)) in order to better explain the configuration and the characteristics of the machine tool 1000 according to the invention.

View a) shows, in addition to the work spindle 100, which can be fed along the x, y and z axes, the machine bed 1100 and the pivotable machine table 200, a workpiece magazine 300 (here in this specific case a wheel magazine, but this is not is to be understood as restricting, since it can also be, for example, a chain magazine or the like) and a workpiece changing device 400.

The workpiece changing device 400 includes a linear axis 420 and a gripper portion 450 rotatable about a rotational axis 410 of the workpiece changing device 400. In the embodiment shown, the gripper portion 450 is configured as a fork gripper, but this is again not to be understood as restricting; other designs, such as a hook gripper, for example, may also be provided as the gripper portion.

As shown, the linear axis 420 is configured as a spindle-driven moving unit and thus enables the changer unit (comprising the gripper portion 450, the rotational axis 410 and a lifting unit 440 for positioning the gripper portion 450 along the rotational axis 410) moved thereon to be positioned very quickly and precisely.

The pivotable machine table 200 includes an substantially U-shaped support 210 which can be pivoted into various positions via a pivot axis 230, wherein the position shown in views a) and b) illustrates the changing position to which the pivotable machine table 200 or the substantially U-shaped carrier 210 is pivoted so that the workpiece changing device 400 can interact with the pivotable machine table and the workpiece WS received or clamped by the machine table 200 can be introduced or exchanged.

Here, however, it should be pointed out once again that, in addition to a pivotable U-shaped machine table 200, various other forms of swivel tables/swivel rotary tables may also be used. For example, the machine table may be mounted on two sides, regardless of whether the carrier (bridge) is U-shaped or, for example, straight.

Furthermore, machine tables mounted on one side may also be provided in the machine tool 1000, as are described, for example, in the patent applications DE 10 2004 049 525 B3 and DE 10 2012 201 736 B3. These can also be pivoted into a corresponding changing position by means of their pivot axis and thus be equipped with workpieces WS by the workpiece changing device 400.

The U-shaped machine table 200 selected by way of example is therefore not to be understood as restricting. The configurations of the machine table 200 mentioned or described below may also be used/provided on other machine tables (mounted on both sides/on one side; straight, U-shaped or L-shaped supports 210).

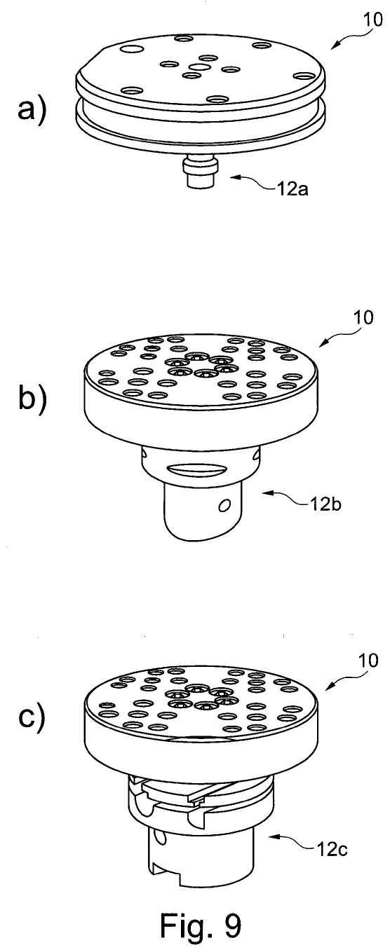

The pivotable machine table 200 may also include a clamping device 220 that can be positioned by rotating about a rotational axis 240, so that the clamped workpiece WS and/or possibly also a workpiece carrier 10 (pallet) with an existing interface 12a, 12b, 12c (not shown here, see FIG. 9), which might allow the clamping of the workpiece WS in the clamping device 220 in the first place, can be positioned by rotating.

View b) shows the workpiece magazine 300, which includes a large number of magazine locations 310 in order to receive workpieces WS accordingly, in more detail. In this case, complete blanks, that is to say completely unmachined workpieces WS, may be received by the workpiece magazine 300 or workpieces WS already machined by another machine tool or in a previous machining step may be received.

In order to provide the respectively required workpiece WS or magazine location 310 in a changing position in which the workpiece magazine 300 can interact with the workpiece changing device 400, the workpiece magazine 300 can be positioned by rotating about a rotational axis 320. This allows for the desired workpiece WS to be gripped (and removed) from the workpiece magazine 300 by the gripper portion 450 of the workpiece changing device 400 or the workpiece WS carried by the gripper section 450 to be deposited at the corresponding magazine location 310 in the first place.

Furthermore, a defined and reproducible changing position of the workpiece magazine 300 may also be required so that the workpiece WS can be gripped smoothly by the gripper portion 450, in particular in the case of interfaces (which can be gripped by the gripper portion 450, for example) as shown in FIG. 9b). Such interfaces require a specific position relative to the gripper portion 450 in order to be able to be gripped. If this is not the case, the workpiece WS, the interface (here, for example, 12b), the gripper portion 450 and/or even the workpiece magazine 300 may be jammed or, in worse cases, even damaged.

Therefore, it is also important for workpiece changing processes such as carried out by the machine tool 1000 according to the invention that a very precise alignment of the corresponding magazine location 310 of the workpiece magazine 300, the gripper portion 450 of the workpiece changing device 400 and the clamping device 220 of the pivotable machine table 200 (or of the machine table 200 itself or the carrier 210 thereof) to one another is carried out.

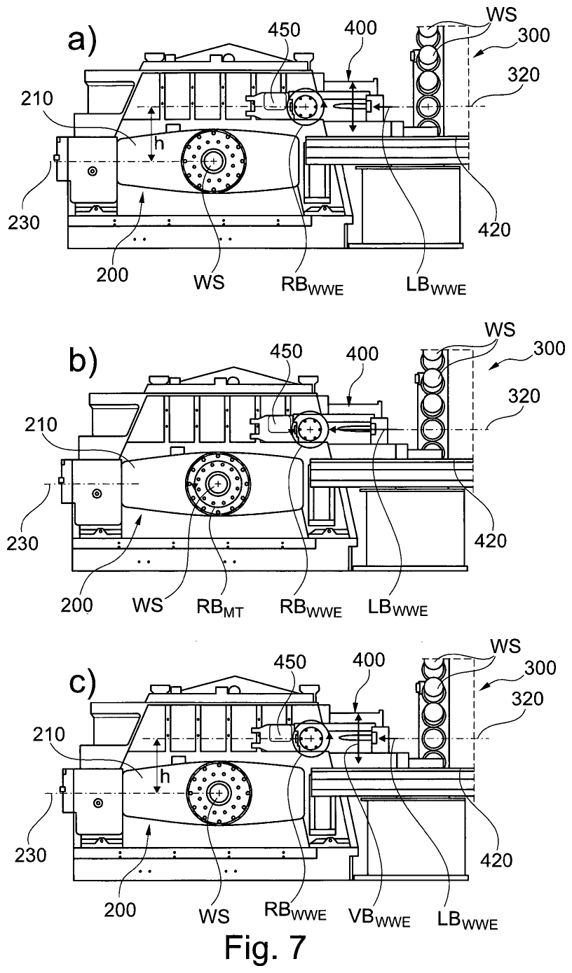

For this reason, the corresponding magazine location 310 (orientation 330), the rotational axis 410 of the gripper portion 450 and the clamping device 220 (illustrated by the rotational axis 240) are oriented substantially parallel to one another (as shown, e.g., in FIG. 7) when the workpiece WS is being introduced or exchanged on the machine table 200, wherein the corresponding magazine location 310 and the clamping device 220 may even be oriented in the same way, but do not have to, which may be dependent on the structure of the machine tool 1000 and/or dependent on the available degrees of freedom of the workpiece changing device 400.

The same orientation (with parallelism) of the magazine location 310 and the clamping device 220 is said to exist when the workpiece WS (and, for example, a hollow shank cone as interface 12c (see FIG. 9)) can be inserted into the corresponding magazine location 310 and into the clamping device 220 when the workpiece WS (and the interface 12c) is displaced along the three spatial directions (x, y, z directions) and possibly rotated in the rotational symmetry axis of the hollow shaft cone.

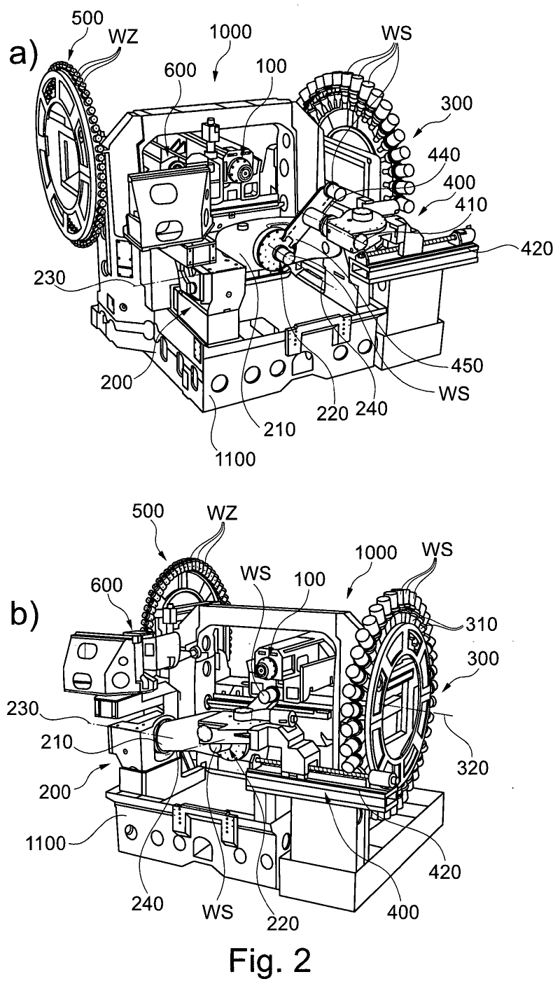

FIG. 2 schematically shows a further embodiment of the machine tool 1000 according to the invention as a horizontal processing machine with a horizontally arranged work spindle 100 and a pivotable machine table 200.

The shown configuration of the machine table 200 on the machine bed 1100, the workpiece magazine 300 and the workpiece changing device 400 with the lifting unit 440 is substantially the same as the already described configuration shown in FIG. 1. Only the position of the work spindle 100 has changed from a vertical arrangement to a horizontal arrangement, supposedly making it clear that the invention may also be used for different designs of machine tools.

Moreover, the machine tool 1000 in FIG. 2 further comprises a tool magazine 500 and a tool changing device 600, which, however, are substantially configured comparably to the workpiece magazine 300 and the workpiece changing device 400. Here, it should be pointed out that a tool magazine 500 and a corresponding tool changer 600 may also be used in the machine tool 1000 according to FIG. 1, but due to the changed position of the work spindle 100 in a correspondingly changed position relative to the tool magazine 500.

Furthermore, it should be pointed out here that it is entirely possible to equip the workpiece magazine 300 with tools WZ and to equip the tool magazine 500 with workpieces WS so that the workpiece WS to be machined can be received by the work spindle 100 and the tool WZ can be received by the pivotable machine table 200.

In addition, the “swapping” of the equipment in the workpiece magazine 300 and the tool magazine 500 may also be used to allow the workpiece WS to be transferred between the machine table 200 and the work spindle 100. For this purpose, the workpiece WS may be clamped in a corresponding clamping device (for example a jaw chuck; not shown here) on the machine table, wherein the tool WZ received by the work spindle 100 is now exchanged for another clamping device, and the workpiece WS is transferred from the machine table 200 to the work spindle 100 by appropriate positioning of the work spindle 100 and the machine table 200.

Subsequently, the clamping means received by the machine table 200 could now be exchanged for a tool WZ, and thus the side of the workpiece WS not yet machined yet can be machined. This would allow 6-sided machining of the workpiece WS, which could take place completely automatically (without direct intervention by a user, e.g. by reclamping the workpiece WS) on the machine tool 1000

Furthermore, FIG. 2 shows how the gripping portion 450 of the workpiece changing device 400 turns between the two legs of the substantially U-shaped carrier 210, in particular beginning or starting during (simultaneously with) the displacement movement of the gripper portion 450 via the linear axis 420 so that the gripper portion 450 can grip the workpiece WS clamped by the clamping device 220 (or the corresponding interface 12a, 12b, 12c). In this context, reference is again made to FIG. 7, which describes several possible displacing or positioning movements.

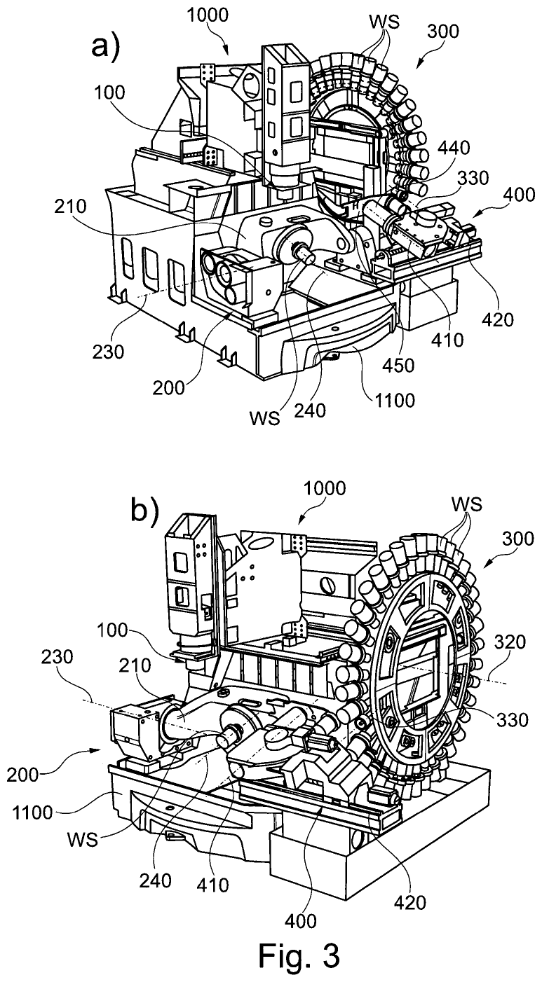

FIG. 3 schematically shows a further embodiment of the machine tool 1000 according to the invention in a traveling column design with vertically arranged work spindle 100, pivotable machine table 200 and obliquely arranged workpiece changing device 400. Here again, reference is made to the explanations relating to FIG. 1 regarding the description of the work spindle 100, the machine table 200 on the machine bed 1100, the workpiece magazine 300 and the workpiece changing device 400 with the lifting unit 440.

It is apparent that the workpiece changing device 400 is provided lower in the machine tool 1000 than the workpiece changing device 400, as shown in FIG. 1, and/or the workpiece magazine 300 was placed higher in the machine tool 1000 with respect to the workpiece changing device 400. This may be necessary, for example, when particularly long workpieces WS are to be received by the workpiece magazine 300, for example in order to have enough space available with respect to the hall floor or the floor of the machine tool 1000.

This may mean that the workpiece changing device 400 can no longer pick up the workpiece WS from a horizontal position in the workpiece magazine 300 (or deposit it), but can only use magazine locations 310 for this purpose that are arranged below the horizontal position or below a horizontal plane extending through the rotational axis 320 of the workpiece magazine 300. The workpiece changing device 400 must therefore be positioned/angled at a certain angle with respect to the machine bed 1100 so that the gripper portion 450 can grip the workpiece WS (or the interface 12a, 12b, 12c) as usual (substantially parallel arrangement of the orientation 330 of the corresponding magazine location 310 and the rotational axis 410 of the workpiece changing device 400.

If the workpiece WS carried by the workpiece changing device 400 is now to be inserted/clamped in the clamping device 220 of the pivotable machine table 200, the changing position of the machine table 200 (a corresponding pivoting movement of the carrier 210 around the pivot axis 230) must be adapted to the angle of incidence of the workpiece changing device 400, so that the rotational axis 240 of the clamping device 220 of the machine table 200 is again arranged substantially in parallel to the rotational axis 410 of the workpiece changing device 400. As a result, an interaction between the machine table 200 and the workpiece changing device 400 for introducing or exchanging the workpiece WS is again possible.

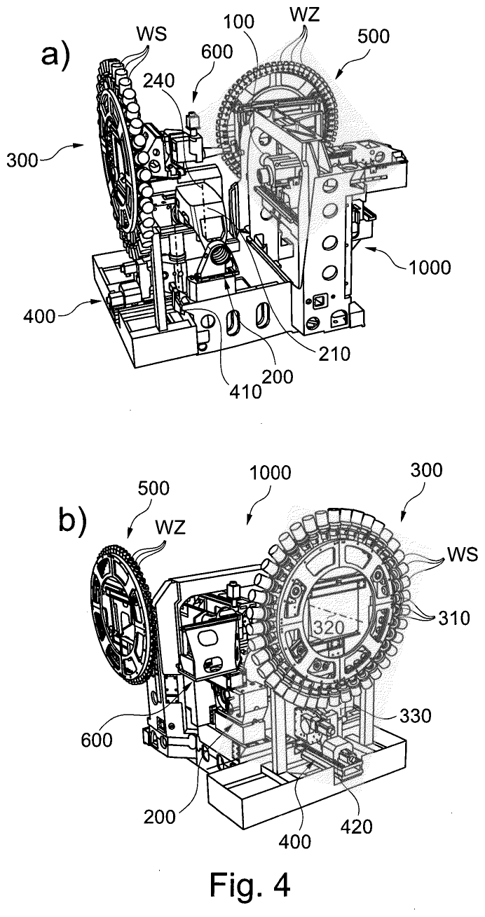

FIG. 4 schematically shows a further embodiment of the machine tool 1000 according to the invention as a horizontal processing machine with a horizontally arranged work spindle 100, a pivotable machine table 200 and a workpiece changing device 400 arranged below a workpiece magazine 300.

The machine tool in FIG. 4 again includes the known elements of the work spindle 100 (here in a horizontal arrangement), a pivotable machine table 200, a workpiece magazine 300, a workpiece changing device 400, a tool magazine 500 and a tool changing device 600.

A special feature of said machine tool 1000 compared to the previously described machine tools is the relative position of the workpiece changing device 400 to the workpiece magazine 300 and correspondingly to the pivotable machine table 200. In the present embodiment, the workpiece changing device 400 is arranged below the workpiece Magazine 300. This may be useful, for example, in the case of unusually long workpieces WS, in order to still realize the most compact structure possible for the remainder of the machine tool 1000 (work spindle 100, machine table 200 and, if necessary, tool magazine 500 and tool changing device 600).

As a result, it may therefore make sense for the gripper portion 450 to pick up or deposit the workpiece WS at the lowest/bottom point of the workpiece magazine 300. The corresponding magazine location 310 is arranged substantially vertically (see orientation 330 of the corresponding magazine location 310).

If the workpiece WS carried by the workpiece changing device 400 is to be inserted/clamped in the clamping device 220 of the pivotable machine table 200, the changing position of the machine table 200 must be adjusted accordingly so that the rotational axis 240 of the clamping device 220 of the machine table 200 is not only arranged substantially in parallel to the orientation 330 of the corresponding magazine location 310 (and also substantially in parallel to the rotational axis 410 of the workpiece changing device 400), but, as in the present case, the clamping device 220 also has the same orientation as the corresponding magazine location 310. For this purpose, for example, the carrier 210 of the machine table 200 can be turned/pivoted “upside down”, as shown in FIG. 4. The workpiece WS can thus be transferred from the gripper portion 450 to the clamping device 220 of the machine table 200 without any problems.

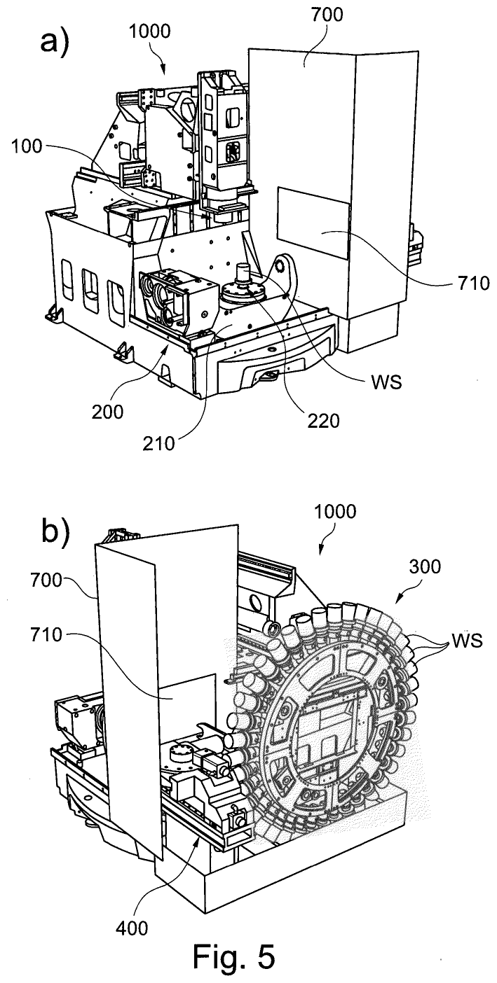

FIG. 5 schematically shows a further embodiment of the machine tool 1000 according to the invention in a traveling column design with a partition 700 of the work space of the machine tool 1000 from the workpiece magazine 300 and the workpiece changing device 400.

The partition 700 also has a closable opening 710 through which the workpiece changing device 400 can be moved into the work space of the machine tool 1000 in order to then carry out the workpiece change in the work space of the machine tool 1000.

The partition 700 of the work space and the area of workpiece storage and the workpiece changing device 400 has the great advantage that various contaminations that are generated during the (cutting) machining of the workpiece WS in the work space of the machine tool 1000 can spread in the work space, while almost no contamination of the partitioned area occurs.

Furthermore, the partition 700 offers the great advantage that the workpiece magazine 300 can, for example, be further equipped by an operator, even while a workpiece WS is being machined by the work spindle 100, without the operator being at risk from material chips flying around or getting too close to moving machine parts (such as the work spindle 100 or the machine table 200/carrier 210).

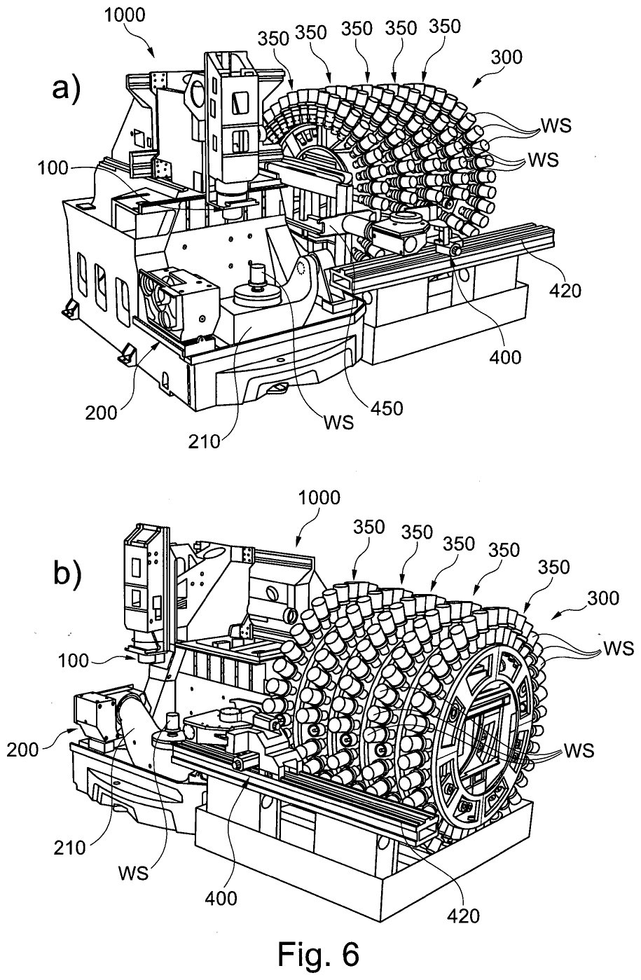

FIG. 6 schematically shows a further embodiment of the machine tool 1000 according to the invention in a traveling column design and a workpiece magazine 300 with a plurality of workpiece magazine portions 350.

Here, the workpiece magazine 300 used for the machine tool 1000 can theoretically be expanded by any number of workpiece magazine portions 350, depending on the requirements placed on the number of stored workpieces WS.

In some cases, a kind of subdivision of the workpiece magazine sections 350 may exist, for example in such a way that a certain number of workpiece magazine portions 350 store the blanks and the remaining workpiece magazine portions 350 receive the workpieces WS coming from the machining on the machine tool 1000.

FIG. 7 schematically shows various combinations of movements of the workpiece changing device 400 and the machine table 200 for gripping the workpiece WS clamped on the machine table 200 by the gripper portion 450 of the workpiece changing device 400.

View a) shows the simplest form of the positioning movement of the workpiece changing device 400 with respect to the machine table 200 in order to change the clamped workpiece WS.

For this purpose, a combination of a linear movement LB_{WWE} of the workpiece changing device 400 along the linear axis 420 and a rotational movement RB_{WWE} of the Gripper Portion 450 of the Workpiece Changing Device 400 is carried out.

In particular, first a workpiece WS is taken from the corresponding magazine location 310 of the workpiece magazine 300 and picked up by the gripper portion 450, which is in a horizontal orientation here. The workpiece changing device 400 is then moved via the linear axis 420 in the direction of the machine table 200, wherein the machine table 200 (or the carrier 210) is pivoted to the changing position about the pivot axis 230 or already is already there.

As soon as the free end of the gripper portion 450 has been moved beyond the workpiece magazine-side leg of the substantially U-shaped carrier 210, the gripper portion 450 of the workpiece changing device 400 begins a rotational movement RB_{WWE} about the rotational axis 410 already during this movement (linear movement LB_{WWE}) so that the free end of the gripper portion 450 approaches the clamping device 220 between the two legs of the substantially U-shaped carrier 210 of the machine table 200.

This combination of the linear movement LB_{WWE} and the rotational movement RB_{WWE} is continued until the free end of the gripper portion 450 can grip the workpiece WS clamped in the clamping device 220. The clamping device 220 can now release the clamping of the workpiece WS and the gripper portion 450 can pull the workpiece WS out of the clamping device 220 with a lifting movement along the rotational axis 410.

The combination of the linear movement LB_{WWE} and the rotational movement RB_{WWE} may therefore also be carried out in order to compensate/overcome the height offset h (see view a)) between the corresponding magazine location 310 (or the workpiece changing device 400) and the workpiece WS clamped in the clamping device 220.

The advantage of this solution is that a vertical axis on the workpiece changing device 400 for compensating the height offset h (see also view c)) can be omitted, whereas the sequence of movements for gripping the workpiece WS clamped on the clamping device 220 becomes more complex (superposition of two movements LB_{WWE} and RB_{WWE}).

Once this has been done, the gripper portion substantially carries out a rotation by 180° about the rotational axis 410, and thereby brings the workpiece WS taken from the workpiece magazine 300 into a position opposite the clamping device 220, so that the gripper portion 450 can insert the workpiece WS to be machined into the clamping device 220 by means of a lifting movement along the rotational axis 410 towards the clamping device 220.

After completed clamping, the gripper portion 450 moves out of the engagement position again by a combination of the linear movement LB_{WWE} and the rotational movement RB_{WWE}, but in the opposite direction, and may then be rotated back about the rotational axis 410 to its horizontal orientation and may then again deposit the workpiece WS taken from the clamping device 220 in the workpiece magazine 300 in one of the magazine locations 310.

View b) shows a further sequence of movements, which substantially corresponds to that shown in view a), but with an additional rotational movement RB_{MT} of the clamping device 220 and thus a rotational movement of the workpiece WS.

Such an additional rotational movement RB_{MT} of the clamping device 220, as shown in view b), may be required, for example, when a workpiece WS or an interface (for example, such as 12b in FIG. 9) has notches for gripping the gripper portion 450 only at certain points on the circumference. If this additional rotational movement RB_{MT} would not take place, the gripper portion 450 could grip the workpiece WS or the interface 12b to some extent, but if the combination of LB_{WWE} and RB_{WWE} were continued, the gripper portion 450 would collide with the workpiece WS or the interface 12b, and this may sometimes lead to damage to machine parts, in particular the gripper portion 450.

It should be noted here that the rotational movement RB_{WWE} and the rotational movement RB_{MT} must always be in the same direction in order to prevent the gripper portion 450 from colliding with the workpiece WS or the interface 12b.

Furthermore, with such interfaces, as shown for example in view b) of FIG. 9, it may be necessary for the machine control of the machine tool 1000 to store in which of the magazine locations 310 of the workpiece magazine 300 such interfaces are used on the workpieces WS or are in use so that, when these workpieces WS/these interfaces are introduced, the machine control system can control the additional rotational movement RB_{MT} accordingly.

View c) shows, as already indicated above, the linear movement LB_{WWE} of the workpiece changing device 400 and the rotational movement RB_{WWE} of the gripper portion 450 as well as a vertical movement VB_{WW}E of the workpiece changing device 400 (substantially also a linear movement, only in the vertical direction) via a linear axis not shown here in more detail in order to compensate/overcome the height offset h between the corresponding magazine location 310 (or the workpiece changing device 400) and the workpiece WS clamped in the clamping device 220.

The advantage of this variant is that the mentioned movements no longer necessarily have to be combined with one another in the form of a combined simultaneous movement of all three or at least two movements. In the simplest case, the linear movement LB_{WWE} moves the workpiece changing device 400 as far as necessary towards the machine table 200, whereupon the gripper portion 450 is substantially rotated by 90° by the rotational movement RB_{WWE}, so that the free end of the gripper portion 450 is positioned above the workpiece WS clamped on the machine table 200. The workpiece changing device 400 is then lowered in the vertical direction by the vertical movement VB_{WWE}, so that the free end of the gripper portion 450 comes into engagement with the workpiece WS clamped on the machine table 200.

The further processes and steps for changing the workpiece WS clamped on the machine table 200 have been sufficiently described above and are therefore not repeated at this point.

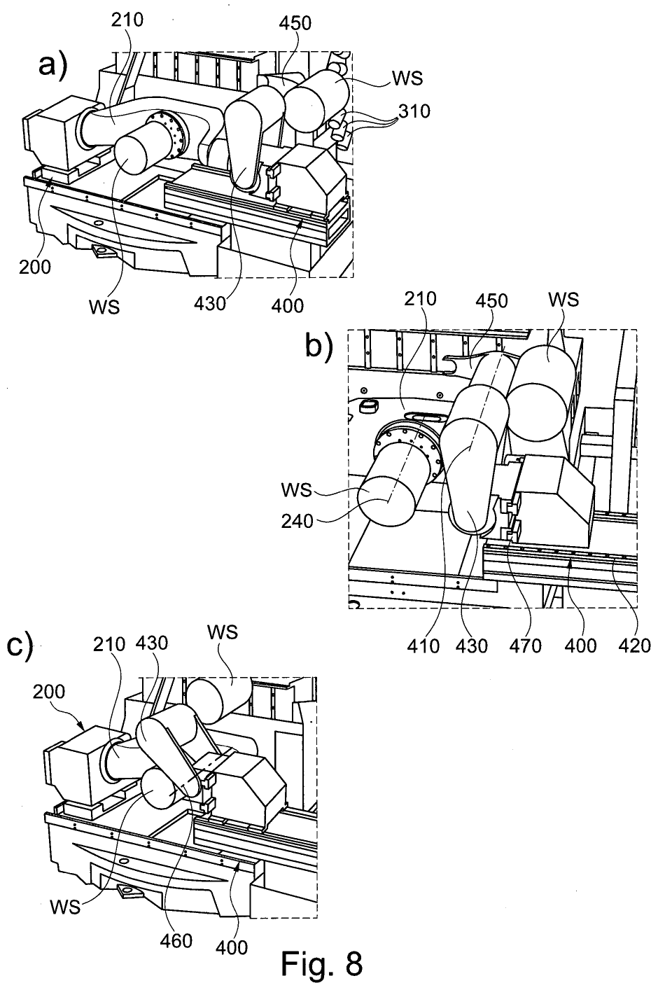

FIG. 8 schematically shows a further embodiment of the workpiece changing device 400 with a further movement for introducing or exchanging the workpiece WS clamped on the machine table 200 (in the views a) to c)).

In addition to the linear axis 420, the workpiece changing device 400 includes a second linear axis 470 moving in the horizontal direction (see in particular view b)), which moves the gripper portion 450 in the direction or in the opposite direction of the clamping device 220 of the machine table 200 during a workpiece change.

Moreover, the workpiece changing device 400 may also have its own pivot axis 460 in order to pivot a pivot portion 430, which includes the rotation axis 410 and the gripper portion 450, about the pivot axis 460 (see in particular view c)) and thus to compensate/overcome the height offset h (as already described above) between the corresponding magazine location 310 (or the workpiece changing device 400) and the workpiece WS clamped in the clamping device 220.

Here, the pivot movement about the pivot axis 460 can be carried out in combination with the already mentioned movements LB_{WWE}, RB_{WWE}, RB_{MT} or VB_{WWE} or otherwise separately from one another.

FIG. 9 schematically shows different variants of workpiece carriers 10 (pallets), on each of which at least one workpiece WS can be clamped, with different interfaces 12a, 12b, 12c.

The use of workpiece carriers 10 offers the advantage that a wide variety of workpieces WS can be received by a clamping device 220 (provided on the machine table 200) without having to carry out a separate clamping for each different workpiece WS.

It should therefore be pointed out here that the already described change of the workpiece WS is not necessarily only carried out with the actual workpiece WS, but rather also includes the change of a workpiece WS on such a workpiece carrier 10 (pallet). Therefore, some or all of the magazine locations 310 of the workpiece magazine 300 may also be configured to receive the workpiece carriers 10 via the corresponding interfaces 12a, 12b, 12c.

View a) shows a user-specific embodiment of a workpiece carrier 10 with a circumferential groove provided on the outer circumference of the workpiece carrier 10, which groove can be used by a workpiece changing device 400 to grip the workpiece carrier 10. In order to clamp the workpiece carrier 10 in the clamping device 220, this embodiment also has a user-specific interface 12a.

View b) shows a user-specific embodiment of a workpiece carrier 10, wherein grooves are provided in sections on the outer circumference of the interface 12b, which grooves can be used by a workpiece changing device 400 to grip the workpiece carrier 10. For this purpose, however, the grooves and the gripper portion 450 of the workpiece changing device 400 must be aligned with one another in such a way that it is possible for the gripper portion 450 to engage the grooves of the interface 12b. A corresponding rotation of the interface 12b (for example by means of a clamping device 220 that can be positioned on the machine table 200 by rotating) could be necessary for this purpose. Here, too, the interface 12b is user-specific.

View c) shows a user-specific embodiment of a workpiece carrier 10 with a circumferential groove provided on the outer circumference of the interface 12c, which groove can be used by a workpiece changing device 400 to grip the workpiece carrier 10. In order to clamp the workpiece carrier 10 in the clamping device 220, this embodiment further includes a standardized interface 12a in the form of a hollow shank taper (HSK), wherein the interface may also be configured as a steep taper. The two variants mentioned are not to be understood as restricting and may be replaced by any other standardized interface.

Examples and exemplary embodiments of the present invention and their advantages have been described in detail above with reference to the accompanying figures.

It should be emphasized again that the present invention, however, is in no way limited or restricted to the exemplary embodiments described above and implementation features thereof, but rather further comprises modifications of the exemplary embodiments, in particular those that result from modifications of the features of the described examples or by combining one or more of the features of the examples described are included within the scope of protection of the independent claims.

### LIST OF REFERENCE SYMBOLS

10 workpiece carrier
12a-c interface
100 work spindle
200 (pivotable) machine table
210 U-shaped carrier
220 clamping device of the machine table
230 pivot axis of the machine table
240 rotational axis of the clamping device
300 workpiece magazine
310 magazine location
320 rotational axis of the workpiece magazine
330 orientation of the magazine location
350 workpiece magazine portion
400 workpiece changing device
410 rotational axis of the gripper portion
420 linear axis of the workpiece changing device
430 pivot portion of the workpiece changing device
440 lifting unit of the gripper portion
450 gripper portion
460 pivot axis
470 linear axis of the workpiece changing device
500 tool magazine
600 tool changing device
700 partition
710 opening (closeable) in the partition
1000 machine tool
1100 machine bed
LB_{WWE} linear movement of the workpiece changing device
RB_{MT} rotational movement of the clamping device
RB_{WWE} rotational movement of the workpiece changing device
VB_{WWE} vertical movement of the workpiece changing device
WS workpiece
WZ tool

1. A machine tool, comprising:
a machine table pivotable about a pivot axis for clamping a workpiece,
a workpiece magazine with a plurality of magazine locations for receiving respective workpieces, and
a workpiece changing device for introducing or exchanging a workpiece on said machine table,
wherein said pivotable machine table is configured to pivot into a changing position for introducing or exchanging the workpiece on said machine table by means of said workpiece changing device, and said workpiece changing device is configured to introduce or exchange the workpiece on the machine table pivoted into the changing position.

2. The machine tool according to claim 1, characterized in that
said workpiece magazine includes at least one rotational axis, wherein said workpiece magazine includes a plurality of radially oriented magazine locations arranged around said at least one rotational axis for receiving respective workpieces.

3. The machine tool according to claim 1, characterized in that
said pivotable machine table includes a clamping device oriented perpendicular to said pivot axis for clamping a workpiece,
wherein, in the changing position of said machine table, said clamping device of said machine table is oriented substantially in parallel and/or substantially identically to a magazine location of said workpiece magazine, from which the workpiece is removed by said workpiece changing device and introduced into said clamping device of said machine table or into which the workpiece is introduced from said clamping device of said machine table by said workpiece changing device.

4. The machine tool according to claim 1, characterized in that
said workpiece changing device includes a gripper portion configured to grip the workpiece on said clamping device of said machine table and/or on one magazine location of the plurality of magazine locations of said workpiece magazine,
wherein said workpiece changing device includes a rotational axis about which said gripper portion is rotatable and which, when the workpiece is gripped by said gripper portion, is arranged substantially in parallel to the orientation of said clamping device of said machine table and/or the corresponding magazine location of the plurality of magazine locations of said workpiece magazine.

5. The machine tool according to claim 4, characterized in that
said workpiece changing device removes the workpiece from one magazine location of the plurality of magazine locations of said workpiece magazine or deposits the workpiece in one magazine location of the plurality of magazine locations of said workpiece magazine which is arranged in horizontal plane extending through said rotational axis of said workpiece magazine and/or which is arranged below the horizontal plane extending through said rotational axis of said workpiece magazine.

6. The machine tool according to claim 4, characterized in that
said rotational axis of said workpiece changing device, about which said gripper portion of said workpiece changing device can be rotated, is arranged substantially horizontally.

7. The machine tool according to claim 4, characterized in that
said rotational axis of said workpiece changing device, about which said gripper portion of said workpiece changing device can be rotated, is arranged substantially vertically.

8. The machine tool according to claim 4, characterized in that
said rotational axis of said workpiece changing device, about which said gripper portion of said workpiece changing device can be rotated, is arranged substantially between a horizontal and a vertical arrangement.

9. The machine tool according to claim 1, characterized in that
the workpiece can be received via a standardized interface, in particular an HSK interface or a steep-taper interface, or a user-specific interface from said clamping device of said machine table and/or from one magazine location of the plurality of magazine locations of said workpiece magazine.

10. The machine tool according to claim 1, characterized in that
said workpiece changing device can be moved between said workpiece magazine and said pivotable machine table via a linear axis.

11. The machine tool according to claim 10, characterized in that
said workpiece changing device, when the workpiece clamped by said machine table is introduced or exchanged, is configured to position said gripper portion of said workpiece changing device for gripping the workpiece on said clamping device of said machine table by moving said workpiece changing device along said linear axis and at the same time starting to position said gripper portion by rotating about said rotational axis of said workpiece changing device.

12. The machine tool according to claim 1, characterized in that
said pivotable machine table is configured as a swivel rotary table.

13. The machine tool according to claim 12, characterized in that
said pivotable machine table includes a rotational axis which is oriented perpendicular to said pivot axis and about which said clamping device of said machine table can be rotated for clamping the workpiece, and
said machine table is configured to position said clamping device of said machine table by rotating to allow for the workpiece clamped by said clamping device of said machine table to be gripped by said gripper portion of said workpiece changing device.

14. The machine tool according to claim 9, characterized in that
said machine table is configured to position said clamping device of said machine table depending on the interface of the workpiece, via which the workpiece can be received from said clamping device of said machine table and/or from one magazine location of the plurality of magazine locations of said workpiece magazine, by rotating in order to allow for the workpiece clamped by said clamping device of said machine table to be gripped by said gripper portion of said workpiece changing device, or
said machine table is configured to position said clamping device of said machine table depending on the interface of the workpiece, via which the workpiece can be received from said clamping device of said machine table and/or from one magazine location of the plurality of magazine locations of said workpiece magazine, and depending on the relative position of the interface to said gripper portion of said workpiece changing device by rotating in order to allow for the workpiece clamped by said clamping device of said machine table to be gripped by said gripper portion of said workpiece changing device.

15. The machine tool according to claim 11, characterized in that
said workpiece changing device includes a vertical axis configured for the vertical movement of said gripper portion and said rotational axis of said workpiece changing device,
wherein, when changing the workpiece clamped on said machine table, for gripping the workpiece on said clamping device of said machine table, said workpiece changing device is configured to move said gripper portion and said rotational axis of said workpiece changing device along said vertical axis in order to allow for the workpiece clamped by said clamping device of said machine table to be gripped by said gripper portion of said workpiece changing device.

16. The machine tool according to claim 4, characterized in that
said gripper portion includes a controllable lifting mechanism by means of which said gripper portion can be moved translationally in the direction of said rotational axis of said workpiece changing device, so that the workpiece can be removed from said clamping device of said machine table and/or from the corresponding magazine location of the plurality of magazine locations of said workpiece magazine and/or the workpiece can be introduced into said clamping device of said machine table and/or into the corresponding magazine location of the plurality of magazine locations of said workpiece magazine.

17. The machine tool according to claim 1, characterized in that
said workpiece magazine includes at least one workpiece magazine portion, preferably a plurality of workpiece magazine portions, which are substantially rotatable about said rotational axis of said workpiece magazine and which each include a plurality of radially oriented magazine locations for receiving respective workpieces.

18. The machine tool according to claim 1, characterized in that
said workpiece magazine is configured as a wheel magazine.
